(19) United States
(12) Patent Application Publication
(10) Pub. No.: US 2011/0003176 A1
(43) Pub. Date: Jan. 6, 2011

(54) PROCESS FOR FORMING CONCAVO-CONVEX PATTERNS, AND PROCESS FOR MANUFACTURING MAGNETIC RECORDING MEDIA USING THE SAME

(75) Inventors: Naoyuki Imai, Minato-ku (JP); Katsutoshi Morinaka, Minato-ku (JP); Hiroshi Uchida, Minato-ku (JP); Akira Sakawaki, Ichihara-shi (JP); Masato Fukushima, Ichihara-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/865,649

(22) PCT Filed: Jan. 28, 2009
(86) PCT No.: PCT/JP2009/051342

§ 371 Date: Jul. 30, 2010

(30) Foreign Application Priority Data
Jan. 31, 2008 (JP) 2008-020977

(51) Int. Cl. G11B 5/84; B05D 5/00; B29C 59/02

(52) U.S. Cl. 428/817; 427/256; 216/22; 425/385

(57) ABSTRACT

An object of the present invention is to provide a process for forming concavo-convex patterns which uses a resist-forming material having excellent oxygen etching resistance and long working life and which enables to carry out the imprinting (mold pressing) with good rectangular shape properties at normal temperature.

The process for forming a concavo-convex pattern of the present invention comprises a step (1) of applying a solution containing a silsesquioxane compound of Composition Formula (A) below to a surface of a workpiece to form a thin film, a step (2) of pressing a stamper having a concavo-convex pattern to the thin film; and a step (3) of separating the stamper from the thin film;

R¹R²Si₂O₃ (A)
wherein R¹ and R² are each independently a specific group.

### FIELD OF THE INVENTION

The present invention relates to processes for forming concavo-convex patterns with use of a specific concavo-convex pattern-forming material, and to processes for manufacturing magnetic recording media using concavo-convex patterns formed by the process for forming a concavo-convex pattern.

### BACKGROUND OF THE INVENTION

Techniques have been established to form a fine concavo-convex structure on the surface of a workpiece with a high throughput. For example, the following technique is known.

A film is formed on the surface of a workpiece, and a mold having a concavo-convex pattern is pressed to the film to transfer the concavo-convex pattern to the film. Using the concavo-convex patterned film formed thereby as a resist, the workpiece is processed.

This technique is referred to as nanoimprint lithography (hereinafter, abbreviated as nanoimprinting). The workpieces herein are materials on which concavo-convex pattern is formed. Examples thereof include bases such as glass plates, substrates that have a base and a magnetic film or a protective film formed thereon, and masked bases or substrates.

Thermoplastic polymers such as polymethyl methacrylate (PMMA) have been hitherto used as materials for forming the concavo-convex patterns, namely, resists (A method proposed by Steohen Y. Chou, et al. See Non-patent Document 1.). Accordingly, the nanoimprinting with such resist-forming materials entails heating during the mold pressing. There was a problem that, during cooling after the mold pressing, the patterns that have been transferred by the mold pressing move and change the linewidths due to the temperature changes. Further, the heating and cooling steps deteriorate operating properties in the nanoimprinting and cause an inconvenience that the resist-forming materials attach to the mold mask in the transfer step, resulting in lowered precision of pattern transferring.

Patent Document 1 discloses a technique in which a siloxane compound, in detail hydrogenated silsesquioxane, is used as a resist-forming material. In the technique, a coating film of the material is formed on a substrate and is pressed with a mold at room temperature, and the hydrogenated silsesquioxane is cured by hydrolysis to give a fine concavo-convex pattern. Patent Document 2 discloses a technique in which a coating film consisting of a composition containing a catechol derivative and a resorcinol derivative is formed on a substrate, the film is pressed with a mold at room temperature, and the composition is cured to give a fine concavo-convex pattern.

As for the former method involving the hydrogenated silsesquioxane, a drawback associated therewith is that it is very difficult to make full use of the method in the industrial production of fine concavo-convex patterns (resists). The hydrogenated silsesquioxane is unstable, and coating solution containing the compound has a short life. Further, after the solution is applied to the substrate and the solvent is dried therefrom, the working life is short.

The latter method using the organic materials has another drawback. The composition containing the catechol derivative and the resorcinol derivative has low resistance to oxygen, and therefore the method has restrictions in particular in the processing of magnetic media that are highly resistant to etching with oxygen gas.

On the other hand, as known in the art, the resist patterns fabricated by the nanoimprinting as described above are transferred to magnetic films by methods such as dry etching. Dry etching refers to a method in which an etching gas is blown to a substrate having a resist pattern and thereby the portions of the substrate on which the resist is not formed are selectively partially or completely removed. Such removal is possible because the resist and the substrate have different removability with the etching gas. In detail, the resist is hard to be removed and the substrate is easy to be removed.

However, unlike silicone wafers used in semiconductors, magnetic films are made of metal oxides that have high resistance to etching gas (usually oxygen gas). Accordingly, even though the hydrogenated silsesquioxane or the like which has relatively high resistance to etching gas is used as a resist-forming material, the concavo-convex shapes of the resists, namely the rectangular shapes, are deformed and the magnetic films are not patterned finely.

In Comparative Example 1 of Patent Document 3, a propylene glycol monomethyl ether acetate solution of poly(phenyl silsesquioxane) is spin coated on a glass substrate, and the thin layer formed on the substrate by the coating is pressed to a mold to form a fine pattern on the substrate.

Non-patent Document 1: Appl. Phys. Lett., Vol. 76, p. 3114 (1995)

Patent Document 1: JP-A-2003-100609

Patent Document 2: JP-A-2005-277280

Patent Document 3: JP-A-2008-194894

### SUMMARY OF THE INVENTION

It is therefore an object of the present invention to provide the following two processes.

(1) A process for forming concavo-convex patterns which involves a resist-forming material having excellent oxygen etching resistance and long working life and which enables to carry out imprinting (mold pressing) with good rectangular shape properties at normal temperature.

(2) A process for manufacturing magnetic recording media which can create patterns on workpieces such as substrates having a magnetic film, with good rectangular shape properties using the concavo-convex patterns fabricated by the process (1).

As used herein, the words “good rectangular shape properties” mean that the concavo-convex patterns have concaves and convexes with clearly defined lines and corners. The properties may be evaluated visually or with electron microscope images.

The present inventors studied diligently to achieve the above object. They have then found that the objects (1) and (2) are solved by using a solution which contains a silsesquioxane compound having the composition formula R¹R²Si₂O₃ and a specific weight average molecular weight.

When the workpieces on which concavo-convex patterns are formed using the concavo-convex patterns of resist are substrates having a magnetic film, it is difficult to fabricate concavo-convex patterns in the magnetic film with good rectangular shape properties because the magnetic film has high ion etching resistance. The present inventors have also found that the magnetic film having concavo-convex patterns with good rectangular shape properties can be formed by providing a thin carbon film having high ion milling resistance on the magnetic film and performing oxygen etching beforehand to form patterns consisting of the resist and the thin carbon layer on the magnetic film.

In detail, the present invention pertains to the following [1] to [13].

[1] A process for forming a concavo-convex pattern, comprising:

a step (1) of applying a solution containing a silsesquioxane compound of Composition Formula (A) below to a surface of a workpiece to form a thin film, the silsesquioxane compound having a weight average molecular weight of not less than 10000 as measured by gel permeation chromatography based on polystyrene standards;

a step (2) of pressing a stamper having a concavo-convex pattern to the thin film; and

a step (3) of separating the stamper from the thin film;

R¹R²Si₂O₃ (A)

wherein R¹ and R² are each independently an optionally substituted C1-8 alkyl group, an optionally substituted C2-8 alkenyl group, an optionally substituted C1-6 alkoxy group or an optionally substituted C6-10 aryl group.

[2] The process for forming a concavo-convex pattern as described in [1], wherein the step (2) is performed at a temperature in the range of 10 to 40° C.

[3] The process for forming a concavo-convex pattern as described in [1] or [2], wherein in the step (2), the stamper is pressed at a pressure in the range of 100 to 250 MPa.

[4] The process for forming a concavo-convex pattern as described in [1], wherein the silsesquioxane compound comprises repeating units of a structure represented by Formula (B) below:

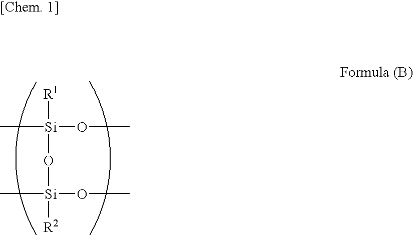

wherein R¹ and R² are each independently an optionally substituted C1-8 alkyl group, an optionally substituted C2-8 alkenyl group, an optionally substituted C1-6 alkoxy group or an optionally substituted C6-10 aryl group.

[5] The process for forming a concavo-convex pattern as described in [4], wherein R¹ and R² in Formula (B) are each independently a methyl group or a phenyl group.

[6] The process for forming a concavo-convex pattern as described in any one of [1] to [5], wherein the silsesquioxane compound has a weight average molecular weight in the range of 10000 to 30000 as measured by gel permeation chromatography based on polystyrene standards.

[7] The process for forming a concavo-convex pattern as described in any one of [1] to [6], wherein the silsesquioxane compound is poly(diphenyl silsesquioxane).

[8] A process for manufacturing magnetic recording media having a concavo-convex pattern, comprising a step of:

providing a workpiece that is a substrate having a base and a magnetic film thereon, and forming a concavo-convex patterned thin film on the magnetic film by the process for forming a concavo-convex pattern described in any one of [1] to [7];

removing the thin film on bottoms of concaves in the concavo-convex pattern; and

removing at least part of the magnetic film that is exposed as a result of the previous removal and is on bottoms of the concaves.

[9] A process for manufacturing magnetic recording media having a concavo-convex pattern, comprising a step of:

providing a workpiece that is a substrate having a base, a magnetic film and a thin carbon film laminated together in this order, and forming a concavo-convex patterned thin film on the thin carbon film by the process for forming a concavo-convex pattern described in any one of [1] to [7];

removing the thin film on bottoms of concaves in the concavo-convex pattern;

removing the thin carbon film that is exposed as a result of the previous removal and is on bottoms of the concaves; and

removing at least part of the magnetic film that is exposed as a result of the removal of the thin carbon film and is on bottoms of the concaves.

[10] The process for manufacturing magnetic recording media having a concavo-convex pattern as described in [9], wherein the removal of the thin carbon film is performed by etching with oxygen gas, and

the removal of the magnetic film is conducted by ion milling.

[11] The process for manufacturing magnetic recording media having a concavo-convex pattern as described in [9] or [10], wherein the thin carbon film has a thickness of 10 to 30 nm.

[12] A magnetic recording medium manufactured by the process for manufacturing magnetic recording media having a concavo-convex pattern described in any one of [9] to [11].

[13] A magnetic recording/reproducing apparatus equipped with the magnetic recording medium described in [12].

### ADVANTAGEOUS EFFECTS OF THE INVENTION

According to the processes for forming a concavo-convex pattern of the present invention, the solution containing the silsesquioxane compound has a long working life, and even if a thin film formed by applying the solution on a surface of a workpiece is left standing at normal temperature for a long time, the concavo-convex pattern can be transferred to the thin film with good rectangular shape properties.

According to the processes for manufacturing magnetic recording media of the present invention, workpieces such as substrates having a magnetic layer can be patterned with good rectangular shape properties.

### BRIEF DESCRIPTION OF THE DRAWINGS

FIG. 1 illustrates steps in a process for forming a concavo-convex pattern according to the present invention.

FIG. 2 illustrates steps of fabricating a concavo-convex pattern on a workpiece wherein a concavo-convex pattern formed by the process for forming a concavo-convex pattern of the present invention is used as a resist. In FIG. 2(a), the etching gas may be, for example, a fluorine-based gas. In FIG. 2(b), the etching gas may be, for example, an oxygen gas.

FIG. 3 shows a preferred embodiment of the process for forming a concavo-convex pattern on a magnetic film wherein the workpiece is a substrate having a base and a magnetic film thereon. In FIG. 3(a), the etching gas may be, for example, a fluorine-based gas. In FIG. 3(b), the etching gas may be, for example, an oxygen gas.

FIG. 4 shows cross sectional SEM images of a substrate and a thin film. In detail, a solution containing poly(diphenyl silsesquioxane) was applied to the surface of a workpiece to form a thin film, and by means of a stamper, a concavo-convex pattern was transferred to the thin film. (Left: SR-20 (weight average molecular weight: 5470), right: SR-20 (weight average molecular weight: 16900))

FIG. 5 shows cross sectional SEM images of a substrate and a thin film. In detail, a solution containing poly(diphenyl silsesquioxane) was applied to the surface of a workpiece to form a thin film, and by means of a stamper, a concavo-convex pattern was transferred to the thin film after storage of 1 day or 7 days at normal temperature. (Left pictures: SR-20 (weight average molecular weight: 5470), right pictures: SR-20 (weight average molecular weight: 16900), upper pictures: after 1 day, lower pictures: after 7 days)

FIG. 6 is a cross sectional SEM image of a substrate and a thin film. In detail, hydrogenated silsesquioxane was spin coated on the surface of a workpiece to form a thin film, and a stamper was pressed to the thin film after 20 minutes.

FIG. 7 shows cross sectional SEM images of a substrate and a thin film, similar to those illustrated in FIG. 4. In detail, a solution containing poly(diphenyl silsesquioxane) was applied to the surface of a workpiece to form a thin film, and a stamper was pressed to the thin film to transfer a concavo-convex pattern. (Upper left: SR-20 (weight average molecular weight: 5470), upper right: SR-20 (weight average molecular weight: 16900)) Also illustrated are cross sectional SEM images of the substrate after the transferred pattern was subjected to ion milling and etching with oxygen. (Lower left: SR-20 (weight average molecular weight: 5470), lower right: SR-20 (weight average molecular weight: 16900)

12: stamper
14: thin film
16: workpiece
18: thin film to which a concavo-convex pattern is transferred
20: etching gas
22: ion milling
24: thin carbon film

### PREFERRED EMBODIMENTS FOR CARRYING OUT THE INVENTION

The present invention will be described in detail hereinbelow.

A process for forming a concavo-convex pattern according to the present invention includes a step (1) of applying a solution containing a silsesquioxane compound of Composition Formula (A) below to a surface of a workpiece to form a thin film, the silsesquioxane compound having a weight average molecular weight of not less than 10000 as measured by gel permeation chromatography based on polystyrene standards; a step (2) of pressing a stamper having a concavo-convex pattern to the thin film; and a step (3) of separating the stamper from the thin film.

R¹R²Si₂O₃ (A)

The solutions containing the silsesquioxane compounds will be described first.

### [Solutions Containing Silsesquioxane Compounds]

The solutions used in the processes for forming concavo-convex patterns of the present invention contain a specific silsesquioxane compound. The silsesquioxane compounds are represented by Composition Formula (A) below:

R¹R²Si₂O₃ (A)

In Composition Formula (A):

R¹ and R² are each independently an optionally substituted C1-8 alkyl group, an optionally substituted C2-8 alkenyl group, an optionally substituted C1-6 alkoxy group or an optionally substituted C6-10 aryl group.

From the viewpoints of fluidity of the solution and retentivity of rectangular shape properties of the concavo-convex pattern,

they are preferably each independently an optionally substituted C1-4 alkyl group, an optionally substituted C2-4 alkenyl group, an optionally substituted C1-2 alkoxy group or an optionally substituted C6-7 aryl group; and

they are more preferably each independently a C1-4 alkyl group, a C2-4 alkenyl group or a C6-7 aryl group.

The substituent groups for the optionally substituted C1-8 alkyl group or the like include halogen atoms and hydroxyl group.

The C1-8 alkyl groups include methyl group, ethyl group, propyl group and butyl group.

The C2-8 alkenyl groups include vinyl group, allyl group and butenyl group.

The C1-6 alkoxy groups include methoxy group and ethoxy group.

The C6-10 aryl groups include phenyl group and tolyl group.

Of the above groups, the phenyl group and the methyl group are preferred in view of the retentivity of rectangular shape of the thin film when it is pressed with a stamper.

The silsesquioxane compounds have a weight average molecular weight of not less than 10000 as measured by gel permeation chromatography (GPC) based on polystyrene standards. The weight average molecular weight is preferably not more than 30000, and is more preferably in the range of 12000 to 25000, and still more preferably 15000 to 20000. The lower the molecular weight, the higher the fluidity of the silsesquioxane compound is and the easier the replication of the pattern of the stamper is. On the other hand, the etching resistance described later tends to be higher with increasing molecular weight. The present inventors have made evaluations using silsesquioxane compounds with various weight average molecular weights and have found that if the weight average molecular weight is below 10000, thermal stability after nanoimprinting is bad and problems such as sagging are caused. If the weight average molecular weight is in the range of 10000 to 30000, it is ensured that the pattern transferred on the substrate is not deformed by heat which is applied to the substrate when the remaining resist is removed by etching after the pattern is transferred on the substrate by nanoimprinting. If the molecular weight is in excess of 30000, the solution containing the silsesquioxane compound has a high viscosity and the fluidity thereof is lowered. As a result, an excessive pressure is needed in order to perform mold-pressing by the stamper, and the life of the stamper may be shortened.

From the viewpoints of flowability of the solution containing the silsesquioxane compound and retentivity of rectangular shape of the concavo-convex pattern, the silsesquioxane compounds preferably comprise repeating units represented by Formula (B) below:

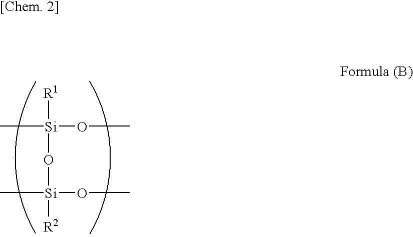

In Formula (B), R¹ and R² are the same as R¹ and R² in Composition Formula (A); in detail, R¹ and R² are each independently an optionally substituted C1-8 alkyl group, an optionally substituted C2-8 alkenyl group, an optionally substituted C1-6 alkoxy group or an optionally substituted C6-10 aryl group. Examples of these groups and preferred groups thereof are as described for R¹ and R² in Composition Formula (A).

The silsesquioxane compounds may be synthesized by known methods. For example, methyl trichlorosilane may be added to a ketone or ether solvent in the presence of amine; water may be added thereto dropwise at a low temperature to hydrolyze the methyl trichlorosilane; and the hydrolyzate may be condensed to give poly(methyl silsesquioxane) (JP-B-H01-43773).

In another method, an alkali metal carboxylate and a lower alcohol may be dissolved in a water/organic solvent two-layered liquid mixture; methyl trichlorosilane may be added dropwise to the system and be hydrolyzed; and the hydrolyzate may be condensed to give poly(methyl silsesquioxane) (Japanese Patent No. 2977218).

Alternatively, phenyl trichlorosilane may be hydrolyzed to give a prepolymer or phenylsilanetriol; and the prepolymer or phenylsilanetriol may be condensed to synthesize poly(phenyl silsesquioxane) in a toluene solvent in the presence of a basic catalyst while azeotropically removing water that is by-produced during the condensation (JP-B-H03-60336 and JP-A-H08-143578).

In still another method, an alkali metal carboxylate and a lower aliphatic alcohol may be dissolved in a water/organic solvent two-layered liquid mixture; phenyl trichlorosilane may be added dropwise to the system and be hydrolyzed; and the hydrolyzate may be condensed to give low-molecular weight poly(phenyl silsesquioxane) having excellent compatibility with organic solvents and a narrow molecular weight distribution (JP-A-H05-39357).

Alternatively, methyltriethoxysilane and phenyltrimethoxysilane may be hydrolyzed in the presence of an acidic catalyst; and the resultant prepolymer may be condensed in a methyl isobutyl ketone solvent in the presence of a basic catalyst to give an ultrahigh-molecular weight poly(methyl phenyl silsesquioxane) (Japanese Patent No. 3272002).

The silsesquioxane compounds used in the process for forming a concavo-convex pattern of the present invention may be synthesized by various known methods as described above, and may also be commercially available.

In fabricating fine concavo-convex patterns using the compounds, the compound may be dissolved in a solvent to obtain solution and it may be applied to the surface of a workpiece by methods such as spin coating or dip coating. Examples of the solvents include ketone solvents such as methyl isobutyl ketone and cyclohexanone;

aromatic hydrocarbon solvents such as toluene and xylene;

ester solvents such as ethyl acetate, butyl acetate and propylene glycol monomethyl ether acetate; and

alcohol solvents such as 2-propanol, butanol, hexanol, propylene glycol mono-n-propyl ether and ethylene glycol monoethyl ether.

The amount of the solvents is usually such that the silsesquioxane compound has a concentration in the range of 1 to 40% by mass, and preferably 3 to 6% by mass based on 100% by mass of the solvents.

Because the solution containing the silsesquioxane compound is used as a resist-forming material, the process for forming a concavo-convex pattern of the present invention provide advantages that all the steps may be performed at normal temperature and that there is no need for a curing reaction unlike the methods of Patent Documents 1 and 2, thereby achieving good working properties. The thin films formed by the process may be used as resists having high oxygen etching resistance. Further, the thin films have a long working life. Hence, even if the thin films are left standing at normal temperature for a long time after formation thereof, they can be patterned with concaves and convexes with good rectangular shape properties.

### [Process for Forming a Concavo-Convex Pattern of the Present Invention]

The process for forming a concavo-convex pattern according to the present invention will be described next.

The process for forming a concavo-convex pattern include a step (an application step) of applying the solution containing the specific silsesquioxane compound to the surface of a workpiece to form a thin film; a step (a transfer step) of pressing a stamper having a concavo-convex pattern to the thin film; and a step (a separation step) of separating the stamper from the thin film.

[symbol]

1. Application Step

[symbol]

The solution containing the silsesquioxane compound is applied to a workpiece such as a substrate to form a thin film on the surface of the workpiece. The thin films may be formed by methods such as spin coating or dip coating. It is preferable to select an appropriate method capable of forming the thin film with a uniform thickness on the substrate. Depending on the application methods, it is desirable to prepare the solution using a solvent which has a boiling point such that no treatments such as prebaking will be required after the application.

[symbol]

2. Transfer Step

[symbol]

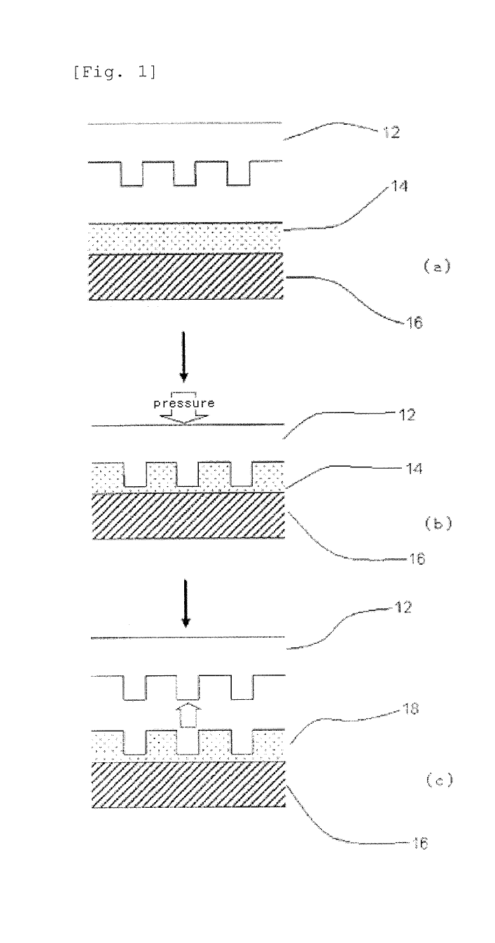

A stamper (a mold having a concavo-convex pattern) is pressed, with pressure at normal temperature, to the thin film formed in the application step to transfer the concavo-convex pattern to the thin film with no particular treatments such as prebaking for the thin film. FIG. 1(b) illustrates the step, in which a stamper is pressed to the thin film formed in the application step.

Throughout the present specification, the term normal temperature indicates temperatures ranging from 0 to 50° C. In a particularly preferred embodiment, the transfer step is performed at a temperature in the range of 10 to 40° C. The step may be generally carried out in the air.

The pressure is usually in the range of 100 to 250 MPa, and more preferably 140 to 180 MPa. On the other hand, excessively low pressure may result in insufficient transfer. Excessively high pressure may shorten the life of stampers and is not economical.

According to the process for forming a concavo-convex pattern of the present invention, fine concavo-convex patterns may be formed on the thin film by the procedures as described above. As used herein, the words fine concavo-convex patterns indicate patterns that are formed on the thin film and have concaves and convexes with a linewidth of not more than 10 μm, in detail patterns in which the total linewidth of one concave and one convex is not more than 10 μm.

[symbol]

3. Separation Step

[symbol]

After the concavo-convex pattern of the stamper has been transferred on the thin film, the stamper is separated from the thin film. FIG. 1(c) illustrates the step, in which the stamper is separated from the thin film.

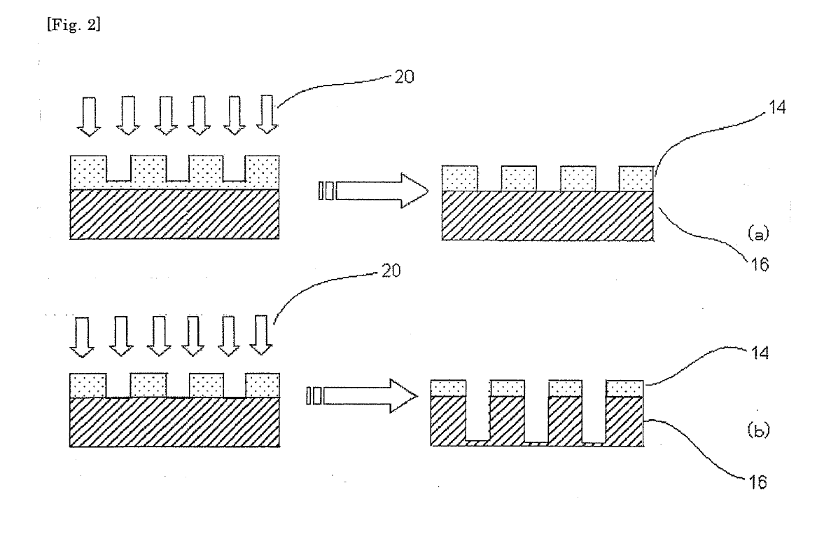

The thin film on which the concavo-convex pattern is transferred as described above can be used as a resist. The remaining portions of the thin film at the bottoms of the concaves are removed by ion etching (residual film treatment) with a fluorine-based etching gas such as CF₄ or SF₆, and thereby the surface of the workpiece is exposed only on the bottoms of the concaves. The workpiece is then etched according to characteristics of the workpiece, and the pattern of the stamper is transferred to the workpiece. FIG. 2(a) illustrates the residual film treatment and FIG. 2(b) shows the etching of the workpiece.

According to the process for forming a concavo-convex pattern of the present invention, as described above, the solution containing the specific silsesquioxane compound is applied to the surface of a workpiece to form a thin film on the workpiece surface, and a stamper is pressed to (mold-pressing) the thin film and is separated from the thin film, thereby forming on the thin film a concavo-convex pattern with good rectangular shape properties. In the process for forming a concavo-convex pattern of the present invention, the resist-forming material has excellent oxygen etching resistance and long working life. Hence, even if the thin films are mold-pressed after the application of the solution on the workpiece surface followed by being left standing at normal temperature for a long time, the thin films can still be transferred with concavo-convex patterns with good rectangular shape properties.

In general, the workpieces may be sufficiently etched by oxygen etching or the like. However, magnetic materials having a base and a magnetic film formed thereon, such as hard disk substrates, have high resistance to various etching gases. Therefore, the above method may not successfully provide concavo-convex patterns on such workpieces with good rectangular shape properties.

In such cases, it is recommended that a thin carbon film such as diamond-like carbon is provided on the magnetic film and the aforesaid thin film is formed thereon. The thin carbon film may be provided on the magnetic film beforehand by known techniques such as CVD or PVD.

In an embodiment using the thin carbon film as above, the process may be performed similarly as described above till the residual film treatment, and steps as described below may be performed thereafter. According to this embodiment, a workpiece (a magnetic film) may be patterned with concaves and convexes with good rectangular shape properties.

[symbol]

Thin Carbon Film Removal Step

[symbol]

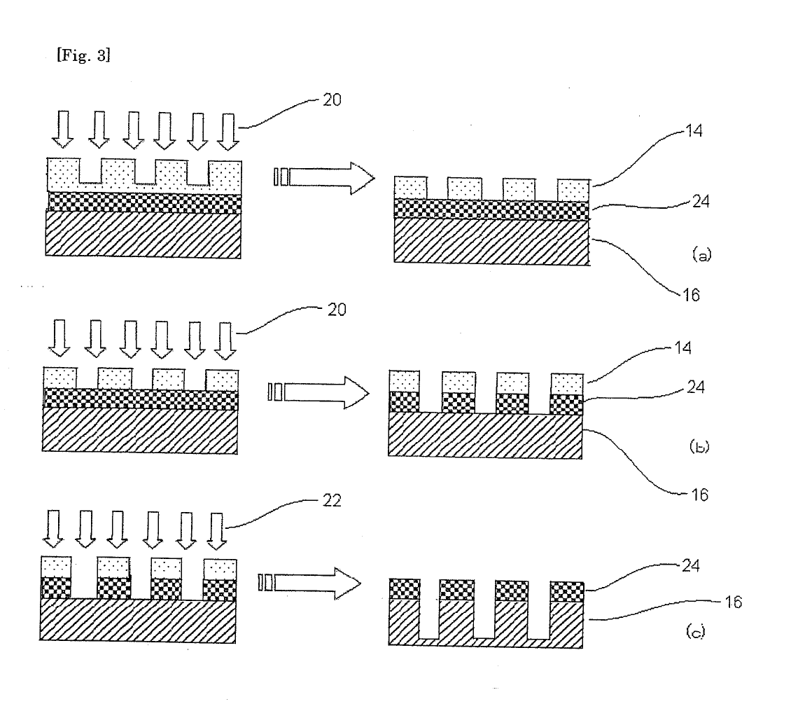

The thin film provided on the thin carbon film is highly resistant to oxygen etching, whilst the thin carbon film has low oxygen etching resistance. Therefore, after the residual film treatment, the thin film and the thin carbon film may be subjected to oxygen etching and thereby the thin carbon film which is not covered with the thin film, namely the thin carbon film which is exposed by the residual film treatment and is on the bottoms of the concaves may be selectively removed. FIG. 3(b) illustrates this step. The thickness of the thin carbon film is usually in the range of 10 to 30 nm.

[symbol]

Magnetic Film Removal Step

[symbol]

After the thin carbon film removal step, by treatment such as ion milling, a portion of the workpiece (magnetic film) which is not covered with the thin carbon film, namely the magnetic film which is exposed by the oxygen etching and is on the bottoms of the concaves may be selectively removed. This selective removal is possible because the diamond-like carbon constituting the thin carbon film is highly resistant to ion milling while the magnetic film has low resistance to ion milling. In the manner as described above, a concavo-convex pattern may be formed on the substrate. The thin film (resist) is also removed by ion milling. FIG. 3(c) illustrates this step.

After the workpieces are patterned, the thin carbon film may be easily removed by ion etching with oxygen gas. Accordingly, the thin carbon film is a favorable masking material in the patterning of magnetic materials.

Workpieces such as substrates having a base and a magnetic film thereon may be processed into concavo-convex patterned magnetic recording media through the steps as described above. In the present invention, the solution which contains the specific silsesquioxane compounds having a weight average molecular weight of not less than 10000 is used. If the weight average molecular weight of the silsesquioxane compounds is less than 10000, the patterned magnetic recording media obtained by removing the thin carbon film as described above have bad rectangular shape properties of the concavo-convex pattern.

The magnetic recording media manufactured by the processes for producing concavo-convex patterned magnetic recording media according to the present invention may be used in various known applications, for example, they can be installed to magnetic recording/reproducing apparatuses.

### Examples and Comparative Examples

The present invention will be described in greater detail based on examples and comparative examples without limiting the scope of the present invention.

Two kinds of poly(diphenyl silsesquioxane) (SR-20 manufactured by KONISHI CHEMICAL INC CO., LTD.) were provided which had different weight average molecular weights. The compounds consisted of repeating units represented by foregoing Formula (B) in which R¹ and R² were phenyl groups (The weight average molecular weights were 5470 and 16900 according to GPC based on polystyrene standards.). A 5% solution of each compound in propylene glycol monomethyl ether acetate (manufactured by DAICEL CHEMICAL INDUSTRIES LTD.) was prepared as a resist solution.

Separately, a substrate having a base and a magnetic film thereon was provided. A thin carbon film was formed in a thickness of approximately 10 nm on the surface of the substrate, namely on the magnetic film, thereby preparing a workpiece.

The resist solution was spin coated on the workpiece surface, namely the thin carbon film, to a thickness of approximately 100 nm.

A nickel stamper (a mold) was provided which had a concavo-convex pattern in which concaves and convexes had respective widths of about 50 to 100 nm and depth of about 50 nm. By means of a press machine, the stamper was pressed to the above-formed thin film at normal temperature and about 180 MPa for 60 seconds, and the pattern was transferred. After the pressing, the stamper was separated and the workpiece surface was confirmed to have a concavo-convex pattern transferred from the stamper (FIG. 4).

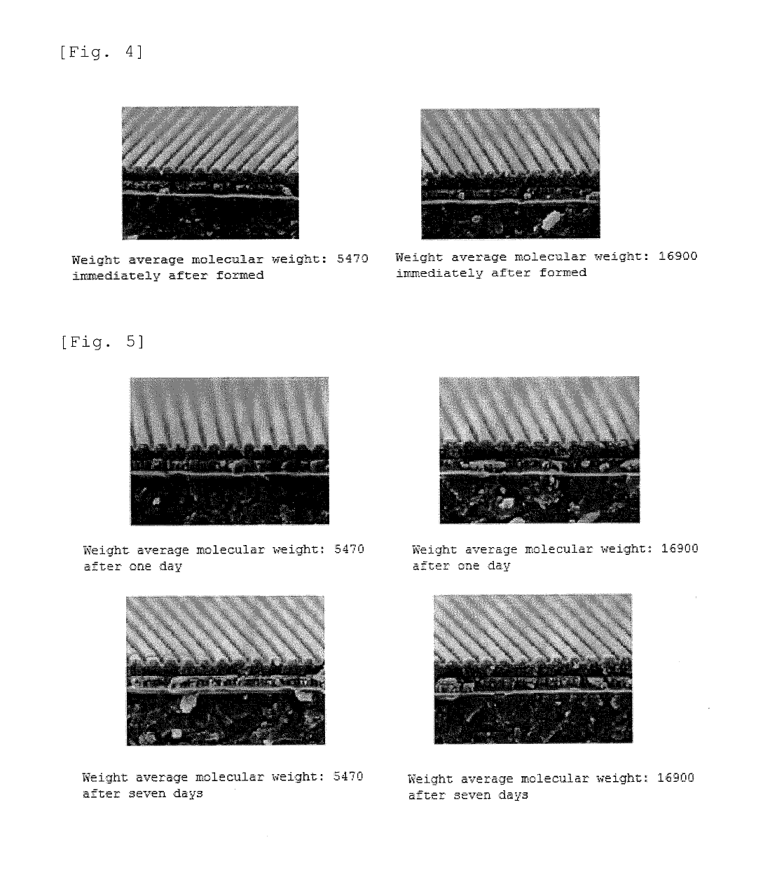

Separately, the resist solution was spin coated and was allowed to stand at normal temperature for one day or seven days. Such workpieces were pressed under the conditions as described above, and the similar transfer of concavo-convex pattern was confirmed (FIG. 5).

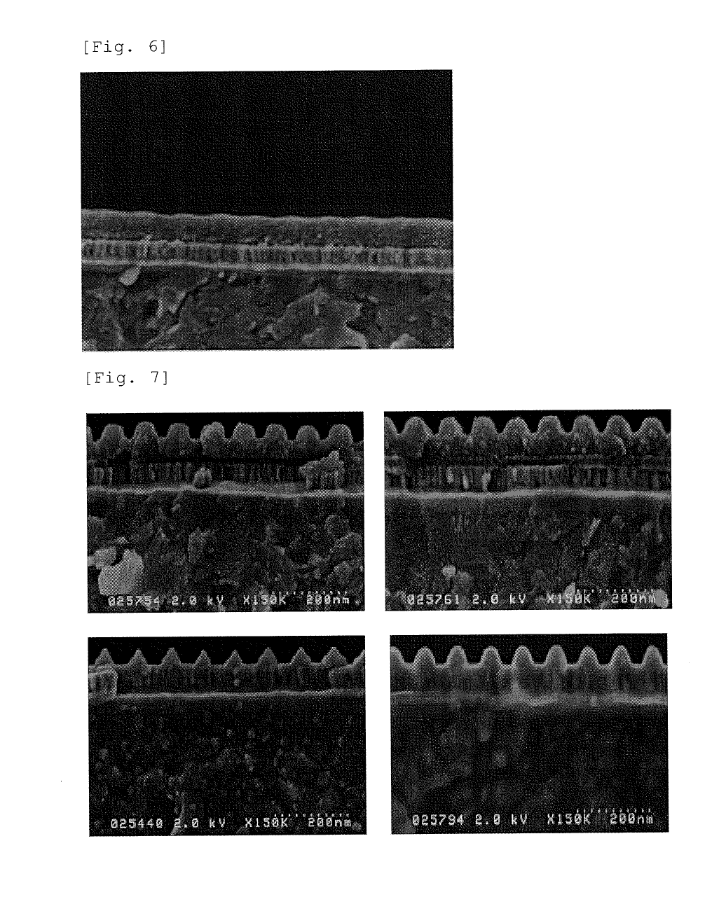

Separately, a solution of hydrogenated silsesquioxane in an organic solvent was spin coated on the surface of a workpiece and was allowed to stand for 20 minutes. The stamper was pressed under the conditions as described above. The shape of concavo-convex pattern obtained is shown in FIG. 6.

Further, the workpieces with the concavo-convex pattern transferred thereon (FIG. 4) were subjected to injection of CF₄ gas (residual film treatment) and O₂ gas (thin carbon film processing) in this order by means of an ion etching apparatus (NE550 manufactured by ULVAC) to remove the resist film portions and the thin carbon film portions in the concaves. Thereafter, the magnetic film (magnetic layer) was processed by ion milling (thereby the remaining resist film was removed), and the remaining thin carbon film was removed by oxygen etching. Discrete track media (magnetic recording media) were thus manufactured.

FIG. 7 illustrates pattern shapes after the transfer (mold-pressing) of concavo-convex pattern to the thin film, and after the removal of the remaining thin carbon film (after oxygen etching) (The upper pictures show shapes after mold-pressing, and the lower pictures show shapes after oxygen etching. The left pictures show the embodiment with weight average molecular weight of 5470, and the right pictures show the embodiment with weight average molecular weight of 16900.). Comparing the results between the weight average molecular weights of 5470 and 16900 shows the following:

(1) In the former embodiment (weight average molecular weight: 5470), the ion milling and the subsequent oxygen etching resulted in a cross sectional shape that was greatly different from the cross sectional shape of the concavo-convex pattern transferred from the stamper on the thin film. That is, the rectangular shape properties of the concavo-convex pattern of the magnetic recording medium were bad.

(2) In the latter embodiment (weight average molecular weight: 16900), the ion milling and the subsequent oxygen etching resulted in a cross sectional shape that was substantially identical to the cross sectional shape of the concavo-convex pattern transferred from the stamper on the thin film. That is, the rectangular shape properties of the concavo-convex pattern of the magnetic recording medium were good.

The solution containing the silsesquioxane compound which was represented by Composition Formula (A) but had a weight average molecular weight of less than 10000 had a long working time and successfully formed a concavo-convex pattern on the substrate with good rectangular shape properties. However, the solution did not allow for the fabrication of the magnetic recording medium which had a concavo-convex pattern with good rectangular shape properties, and thus the manufacturing of target industrial products failed.

1. A process for forming a concavo-convex pattern, comprising:
a step (1) of applying a solution containing a silsesquioxane compound of Composition Formula (A) below to a surface of a workpiece to form a thin film, the silsesquioxane compound having a weight average molecular weight of not less than 10000 as measured by gel permeation chromatography based on polystyrene standards;
a step (2) of pressing a stamper having a concavo-convex pattern to the thin film; and
a step (3) of separating the stamper from the thin film;
R¹R²Si₂O₃ (A)
wherein R¹ and R² are each independently an optionally substituted C1-8 alkyl group, an optionally substituted C2-8 alkenyl group, an optionally substituted C1-6 alkoxy group or an optionally substituted C6-10 aryl group.

2. The process for forming a concavo-convex pattern according to claim 1, wherein the step (2) is performed at a temperature in the range of 10 to 40° C.

3. The process for forming a concavo-convex pattern according to claim 1, wherein in the step (2), the stamper is pressed at a pressure in the range of 100 to 250 MPa.

4. The process for forming a concavo-convex pattern according to claim 1, wherein the silsesquioxane compound comprises repeating units of a structure represented by Formula (B) below: 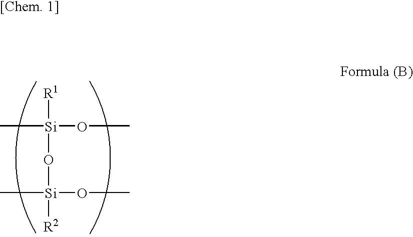
wherein R¹ and R² are each independently an optionally substituted C1-8 alkyl group, an optionally substituted C2-8 alkenyl group, an optionally substituted C1-6 alkoxy group or an optionally substituted C6-10 aryl group.

5. The process for forming a concavo-convex pattern according to claim 4, wherein R¹ and R² in Formula (B) are each independently a methyl group or a phenyl group.

6. The process for forming a concavo-convex pattern according to claim 1, wherein the silsesquioxane compound has a weight average molecular weight in the range of 10000 to 30000 as measured by gel permeation chromatography based on polystyrene standards.

7. The process for forming a concavo-convex pattern according to claim 1, wherein the silsesquioxane compound is poly(diphenyl silsesquioxane).

8. A process for manufacturing magnetic recording media having a concavo-convex pattern, comprising a step of:
providing a workpiece that is a substrate having a base and a magnetic film thereon, and forming a concavo-convex patterned thin film on the magnetic film by the process for forming a concavo-convex pattern as described in claim 1;
removing the thin film on bottoms of concaves in the concavo-convex pattern; and
removing at least part of the magnetic film that is exposed as a result of the previous removal and is on bottoms of the concaves.

9. A process for manufacturing magnetic recording media having a concavo-convex pattern, comprising a step of:
providing a workpiece that is a substrate having a base, a magnetic film and a thin carbon film laminated together in this order, and forming a concavo-convex patterned thin film on the thin carbon film by the process for forming a concavo-convex pattern as described in claim 1;
removing the thin film on bottoms of concaves in the concavo-convex pattern;
removing the thin carbon film that is exposed as a result of the previous removal and is on bottoms of the concaves; and
removing at least part of the magnetic film that is exposed as a result of the removal of the thin carbon film and is on bottoms of the concaves.

10. The process for manufacturing magnetic recording media having a concavo-convex pattern according to claim 9, wherein the removal of the thin carbon film is performed by etching with oxygen gas, and
the removal of the magnetic film is conducted by ion milling.

11. The process for manufacturing magnetic recording media having a concavo-convex pattern according to claim 9, wherein the thin carbon film has a thickness of 10 to 30 nm.

12. A magnetic recording medium manufactured by the process for manufacturing magnetic recording media having a concavo-convex pattern as described in claim 9.

13. A magnetic recording/reproducing apparatus equipped with the magnetic recording medium as described in claim 12.
